(19) United States
(12) Patent Application Publication
(10) Pub. No.: US 2017/0016315 A1
(43) Pub. Date: Jan. 19, 2017

(54) MODEL FOR ONE-DIMENSIONAL TEMPERATURE DISTRIBUTION CALCULATIONS FOR A FLUID IN A WELLBORE

(71) Applicant: Halliburton Energy Services, Inc., Houston, TX (US)

(72) Inventors: Srinath Madasu, Houston, TX (US); Avi Lin, Houston, TX (US)

(21) Appl. No.: 15/301,012

(22) PCT Filed: May 2, 2014
(86) PCT No.: PCT/US14/36620

§ 371 Date: Sep. 30, 2016

(51) Int. Cl. E21B 47/06; G06F 17/11; G06F 17/50; E21B 47/10; E21B 41/00

(52) U.S. Cl. CPC E21B 47/065; E21B 47/06; E21B 47/10; E21B 41/0092; G06F 17/5009; G06F 17/11; E21B 43/25

(57) ABSTRACT

In accordance with some embodiments of the present disclosure, a method of modeling for one-dimensional temperature distribution calculations in a wellbore is disclosed. The method may include estimating a pressure gradient of a fluid in a wellbore. The method may further include calculating a pressure of the fluid in the wellbore based on the pressure gradient of the fluid. Additionally, the method may include computing a velocity of the fluid in the wellbore. The method may also include determining a temperature of the fluid in the wellbore based on the pressure of the fluid in the wellbore and the velocity of the fluid in the wellbore. The method further includes using the temperature of the fluid to model a fluid property. The method includes selecting parameters for a stimulation operation based on the fluid property.

### TECHNICAL FIELD

The present disclosure relates generally to well drilling and hydrocarbon recovery operations and, more particularly, to a model for one-dimensional temperature distribution calculations in a wellbore.

### BACKGROUND

During completion operations in wells, different stimulation techniques may be performed downhole, including nitrogen circulation, acidizing, fracturing, or a combination of acidizing and fracturing. Acidizing and nitrogen circulation are designed to clean up residues and skin damage in the wellbore in order to improve the flow of oil. Fracturing is designed to create fractures in the surrounding formation surrounding the wellbore to allow oil to flow from a reservoir into the well. To enable the use of these stimulation techniques, perforations, or holes, may be created in a downhole casing in the wellbore. The perforations allow acid and other fluids to flow from the wellbore into the surrounding formation. The perforations may also allow oil to flow into the wellbore from fractures in the formation created during fracturing techniques.

During stimulation operations, fluids may be injected into the wellbore. When a fluid is injected in a wellbore, the fluid flow and temperature changes as the fluid travels through the wellbore.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an elevation view of an example embodiment of a drilling system, in accordance with some embodiments of the present disclosure;

FIG. 2 illustrates an elevation view of an example embodiment of a wellbore, in accordance with some embodiments of the present disclosure;

FIG. 3 illustrates a block diagram of an exemplary wellbore modeling system, in accordance with some embodiments of the present disclosure;

FIG. 4 illustrates a flow chart of a method for modeling one-dimensional temperature distribution calculations in a wellbore, in accordance with some embodiments of the present disclosure; and

FIGS. 5A-5C illustrate the results from an exemplary embodiment of a method as shown in FIG. 4, in accordance with some embodiments of the present disclosure.

### DETAILED DESCRIPTION

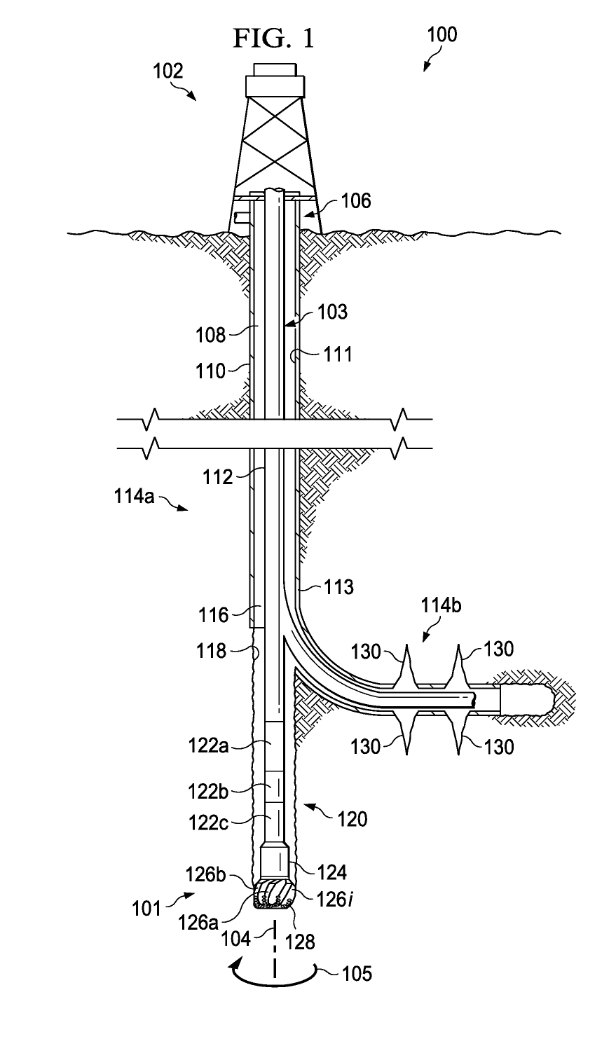

A model for one-dimensional temperature distribution calculations in a wellbore and related systems and methods are disclosed. In broad terms, one aspect of the disclosed model takes into consideration that fluid flow in a wellbore is unsteady. The unsteady fluid flow in a wellbore may vary with time and may be based on an overall heat transfer coefficient. The overall heat transfer coefficient may take into account the heat transfer coefficients of each material between the fluid and the formation. Thus, by considering the unsteady flow and the heat transfer rate through various materials, the disclosed models are able to more accurately analyze and/or predict the temperature distribution of the fluid in a wellbore. The temperature distribution of a fluid in a wellbore may be used to enable the design of perforation zones in the wellbore to effectively deliver fluid to the formation and monitor the temperature of the fluid, in real-time, as the fluid travels through the wellbore and exits the wellbore through the perforations. The temperature of the fluid may impact the properties of the fluid. The properties of the fluid may be used real-time during a stimulation operation to represent the conditions in the wellbore. The conditions in the wellbore may enable an operator to monitor and/or adjust the stimulation operation if necessary. Accordingly, a system and model may be designed in accordance with the teachings of the present disclosure and may have different designs, configurations, and/or dimensions according to a particular application. Embodiments of the present disclosure and its advantages are best understood by referring to FIGS. 1 through 5, where like numbers are used to indicate like and corresponding parts.

FIG. 1 illustrates an elevation view of an example embodiment of drilling system 100, in accordance with some embodiments of the present disclosure. Drilling system 100 may include well surface or well site 106. Various types of drilling equipment such as a rotary table, drilling fluid pumps and drilling fluid tanks (not expressly shown) may be located at well surface or well site 106. For example, well site 106 may include drilling rig 102 that may have various characteristics and features associated with a “land drilling rig.” However, downhole drilling tools incorporating teachings of the present disclosure may be satisfactorily used with drilling equipment located on offshore platforms, drill ships, semi-submersibles and drilling barges (not expressly shown).

Drilling system 100 may also include drill string 103 associated with drill bit 101 that may be used to form a wide variety of wellbores or bore holes such as generally vertical wellbore 114a or generally horizontal 114b wellbore or any combination thereof. Various directional drilling techniques and associated components of bottom hole assembly (BHA) 120 of drill string 103 may be used to form horizontal wellbore 114b. For example, lateral forces may be applied to BHA 120 proximate kickoff location 113 to form generally horizontal wellbore 114b extending from generally vertical wellbore 114a. The term “directional drilling” may be used to describe drilling a wellbore or portions of a wellbore that extend at a desired angle or angles relative to vertical. The desired angles may be greater than normal variations associated with vertical wellbores. Direction drilling may also be described as drilling a wellbore deviated from vertical. The term “horizontal drilling” may be used to include drilling in a direction approximately ninety degrees (90°) from vertical. “Uphole” may be used to refer to a portion of wellbore 114 that is closer to well surface 106. “Downhole” may be used to refer to a portion of wellbore 114 that is further from well surface 106.

BHA 120 may be formed from a wide variety of components configured to form wellbore 114. For example, components 122a, 122b, and 122c of BHA 120 may include, but are not limited to, drill bits (e.g., drill bit 101), coring bits, drill collars, rotary steering tools, directional drilling tools, downhole drilling motors, reamers, hole enlargers or stabilizers. The number and types of components 122 included in BHA 120 may depend on anticipated downhole drilling conditions and the type of wellbore that will be formed by drill string 103 and rotary drill bit 101. BHA 120 may also include various types of well logging tools (not expressly shown) and other downhole tools associated with directional drilling of a wellbore. Examples of logging tools and/or directional drilling tools may include, but are not limited to, acoustic, neutron, gamma ray, density, photoelectric, nuclear magnetic resonance, rotary steering tools and/or any other commercially available well tool. Further, BHA 120 may also include a rotary drive (not expressly shown) connected to components 122a, 122b, and 122c and which rotates at least part of drill string 103 together with components 122a, 122b, and 122c.

Wellbore 114 may be defined in part by casing string 110 that may extend from well surface 106 to a selected downhole location. Portions of wellbore 114, as shown in FIG. 1, that do not include casing string 110 may be described as “open hole.” Various types of drilling fluid may be pumped from well surface 106 through drill string 103 to attached drill bit 101. The drilling fluids may be directed to flow from drill string 103 to respective nozzles passing through rotary drill bit 101. The drilling fluid may be circulated back to well surface 106 through annulus 108 defined in part by outside diameter 112 of drill string 103 and inside diameter 118 of wellbore 114. Inside diameter 118 may be referred to as the “sidewall” of wellbore 114. Annulus 108 may also be defined by outside diameter 112 of drill string 103 and inside diameter 111 of casing string 110. Open hole annulus 116 may be defined as sidewall 118 and outside diameter 112.

Drilling system 100 may also include rotary drill bit (“drill bit”) 101. Drill bit 101 may include one or more blades 126 that may be disposed outwardly from exterior portions of rotary bit body 124 of drill bit 101. Blades 126 may be any suitable type of projections extending outwardly from rotary bit body 124. Drill bit 101 may rotate with respect to bit rotational axis 104 in a direction defined by directional arrow 105. Blades 126 may include one or more cutting elements 128 disposed outwardly from exterior portions of each blade 126. Blades 126 may also include one or more depth of cut controllers (not expressly shown) configured to control the depth of cut of cutting elements 128. Blades 126 may further include one or more gage pads (not expressly shown) disposed on blades 126. Drill bit 101 may be designed and formed in accordance with teachings of the present disclosure and may have many different designs, configurations, and/or dimensions according to the particular application of drill bit 101.

BHA 120 may also include a stimulation assembly (not expressly shown). The stimulation assembly may be configured to create perforations 130 in casing string 110. Perforations 130 may allow for other stimulation activities, such as fracturing, acidizing, matrix acidizing, or any other suitable stimulation activity to be performed in wellbore 114. During stimulation activities, fluid may be injected into wellbore 114. The fluid may travel through wellbore 114 and may exit wellbore 114 at perforations 130. As the fluid travels through wellbore 114, the temperature of the fluid may change. Additionally, the temperature of the fluid may change the properties of the fluid, for example by changing the viscosity of the fluid. The temperature of the fluid as the fluid travels through the wellbore may be an important factor when selecting a fluid to use for the stimulation activity as some fluids may have a maximum temperature threshold.

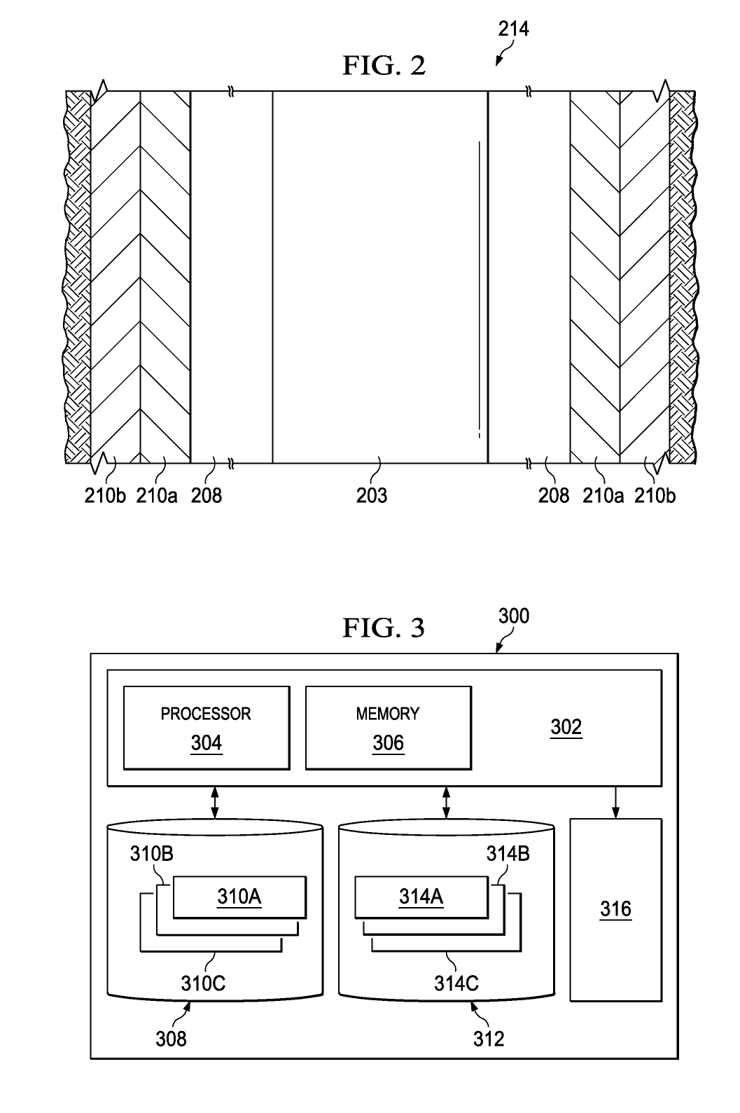

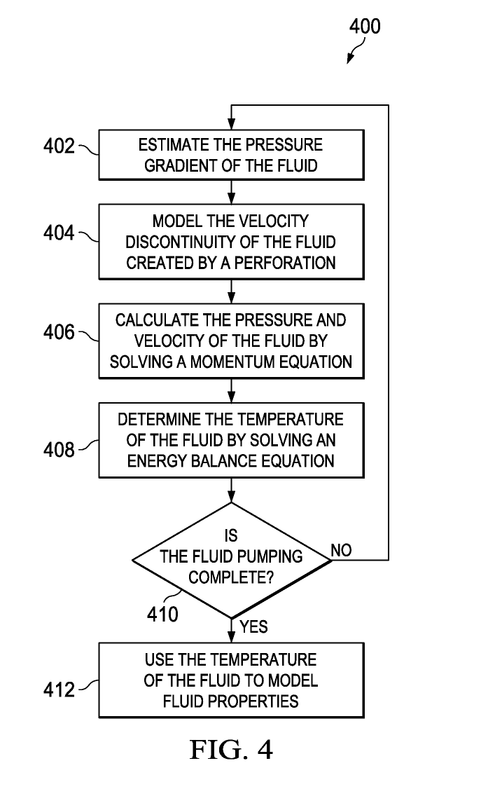

In some embodiments of the disclosure, it may be advantageous to generate a model of the temperature of the fluid as the fluid travels through wellbore 114, as disclosed in further detail with respect to FIGS. 2 and 4. For example, during injection of fluid into wellbore 114, the model may predict the temperature of the fluid and may provide engineers and operators of drilling system 100 with an accurate representation of the conditions in wellbore 114 and may enable engineers to predict and model the behavior of the fluid in wellbore 114. The model may enable perforations 130 in wellbore 114 to be designed to effectively deliver fluid for stimulation operations based on the properties and/or behavior of the fluid. As such, a wellbore modeling system designed according to the present disclosure may improve accuracy of predictions of the distribution of fluid during a downhole operation.

FIG. 2 illustrates an elevation view of an example embodiment of wellbore 214, in accordance with some embodiments of the present disclosure. Wellbore 214 may include drill string 203, annulus 208, casing 210a, and cement 210b. Drill string 203 and annulus 208 may be similar to drill string 103 and annulus 108, as described with respect to FIG. 1. Casing 210a and cement 210b may be similar to casing string 110, as described with respect to FIG. 1. When fluid is injected into wellbore 214, the temperature of the fluid in drill string 203 may change based upon the transfer of heat to the surrounding formation. Heat may be transferred to the formation from the fluid through cement 210b, casing 210a, and annulus 208. The amount of heat transferred through annulus 208, casing 210a, and cement 210b may be based on the thermal resistance of each layer of material between the fluid and the formation. The temperature of the formation increases linearly with depth, therefore the temperature of the fluid and/or the rate of heat transfer may also vary with depth. While wellbore 214 is shown in FIG. 2 as a vertical wellbore, the wellbore modeling system disclosed may be used in horizontal, vertical, or directional wellbores.

FIG. 3 illustrates a block diagram of an exemplary wellbore modeling system 300, in accordance with some embodiments of the present disclosure. Wellbore modeling system 300 may be configured to perform modeling for one-dimensional temperature distribution calculations in a wellbore. For example, wellbore modeling system 300 may be used to perform the steps of method 400 as described with respect to FIG. 4. In some embodiments, wellbore modeling system 300 may include wellbore modeling module 302. Wellbore modeling module 302 may include any suitable components. For example, in some embodiments, wellbore modeling module 302 may include processor 304. Processor 304 may include, for example a microprocessor, microcontroller, digital signal processor (DSP), application specific integrated circuit (ASIC), or any other digital or analog circuitry configured to interpret and/or execute program instructions and/or process data. In some embodiments, processor 304 may be communicatively coupled to memory 306. Processor 304 may be configured to interpret and/or execute program instructions and/or data stored in memory 306. Program instructions or data may constitute portions of software for carrying out modeling for one-dimensional temperature distribution calculations in a wellbore, as described herein. Memory 306 may include any system, device, or apparatus configured to hold and/or house one or more memory modules; for example, memory 306 may include read-only memory, random access memory, solid state memory, or disk-based memory. Each memory module may include any system, device or apparatus configured to retain program instructions and/or data for a period of time (e.g., computer-readable non-transitory media).

Wellbore modeling system 300 may further include fluid property database 308. Fluid property database 308 may be communicatively coupled to wellbore modeling module 302 and may provide fluid property parameters 310a-310c in response to a query or call by wellbore modeling module 302. Fluid property parameters 310a-310c may be implemented in any suitable manner, such as by parameters, functions, definitions, instructions, logic, or code, and may be stored in, for example, a database, file, application programming interface, library, shared library, record, data structure, service, software-as-service, or any other suitable mechanism. Fluid property parameters 310a-310c may specify any suitable properties or parameters for a fluid that may be injected into a wellbore, such as, for example, the density of the fluid, the viscosity of the fluid, and/or the permeability of the fluid, discussed above with reference to FIG. 3. Although fluid property database 308 is illustrated as including three fluid property parameters, fluid property database 308 may contain any suitable number of fluid property parameters.

Wellbore modeling system 300 may further include wellbore material property database 312. Wellbore material property database 312 may be communicatively coupled to wellbore modeling module 302 and may provide wellbore material property parameters 314a-314c in response to a query or call by wellbore modeling module 302. Wellbore material property parameters 314a-314c may be implemented in any suitable manner, such as by parameters, functions, definitions, instructions, logic, or code, and may be stored in, for example, a database, file, application programming interface, library, shared library, record, data structure, service, software-as-service, or any other suitable mechanism. Wellbore material property parameters 314a-314c may specify any suitable properties or parameters of wellbore material that may be used to form a wellbore, such as the heat transfer coefficient of a material and the heat of the earth as a function of depth. Although wellbore material property database 312 is illustrated as including two instances of wellbore material property parameters, wellbore material property database 312 may contain any suitable number of instances of wellbore material property parameters.

In some embodiments, wellbore modeling module 302 may be configured to perform modeling for one-dimensional temperature distribution calculations of a fluid in a wellbore. For example, wellbore modeling module 302 may be configured to import one or more instances of fluid property parameters 310a-310c, and/or one or more instances of wellbore material property parameters 314a-314c. Fluid property parameters 310a-310c, and/or wellbore material property parameters 314a-314c may be stored in memory 306. Wellbore modeling module 302 may be further configured to cause processor 304 to execute program instructions operable to perform modeling for one-dimensional temperature distribution calculations in a wellbore. For example, processor 304 may, based on fluid property parameters 310a-310c and wellbore material property parameters 314a-314c, generate a model of the temperature of a fluid as the fluid travels through a wellbore.

Wellbore modeling module 302 may be communicatively coupled to one or more displays 316 such that information processed by wellbore modeling module 302 (e.g., temperature of the fluid) may be conveyed to operators of drilling equipment.

Modifications, additions, or omissions may be made to FIG. 3 without departing from the scope of the present disclosure. For example, FIG. 3 shows a particular configuration of components of wellbore modeling system 300. However, any suitable configurations of components may be used. For example, components of wellbore modeling system 300 may be implemented either as physical or logical components. Furthermore, in some embodiments, functionality associated with components of wellbore modeling system 300 may be implemented in special purpose circuits or components. In other embodiments, functionality associated with components of wellbore modeling system 300 may be implemented in configurable general purpose circuit or components. For example, components of wellbore modeling system 300 may be implemented by configure computer program instructions.

The temperature of a fluid during travel through wellbore 214 may be calculated by modeling the effect of various layers of wellbore 214, such as annulus 208, casing 210a, and cement 210b, as well as the temperature of the surrounding formation as a function of depth. FIG. 4 illustrates a flow chart of a method 400 for modeling one-dimensional temperature distribution calculations in a wellbore, in accordance with some embodiments of the present disclosure. The steps of method 400 may be performed by various computer programs, models or any combination thereof, configured to simulate and design drilling systems, apparatuses and devices, such as the wellbore modeling system illustrated in FIG. 3. For illustrative purposes, method 400 is described with respect to the wellbore, the perforations, the annulus, the casing string, the casing, and the cement as illustrated in the previous FIGURES; however, method 400 may be used to calculate the temperature of a fluid in any portion of a wellbore.

Method 400 may begin at step 402. At step 402, the wellbore modeling system may compute the pressure gradient of a fluid. The fluid may be a drilling fluid, a fracturing fluid, an acidizing fluid, or any other fluid suitable for use in a wellbore during stimulation operations. The pressure gradient equation may be computed by:

$$\begin{matrix}\frac{D Δ p}{4 L} = {{AD}^{e} ( \frac{8 V}{D} )}^{s} \\ where & ( 1 ) \\ A = \frac{0.046 {ρ}^{0.8} {μ}^{0.2}}{2 \times {8}^{1.8} ℊ} ; & ( 2 )\end{matrix}$$

D=diameter of the wellbore;
V=velocity of the fluid;
Δp=pressure drop in the fluid;
e=fluid dependent parameter obtained from experimental data; and
s=fluid dependent parameter obtained from experimental data.

The values for e and s may be obtained by plotting characteristics of the wellbore and the fluid. For example, s may be calculated by determining the slope of parallel branches described by various pipe diameters under turbulent flow conditions on an ln(DΔP/4 L) versus ln(8V/D) plot. The value for e may be calculated by determining the slope of an ln(AD^{e}) versus ln(D) plot. Both s and e may be dimensionless parameters.

Equation 1 may be used for laminar fluid flow, such as a fracturing fluid with water soluble guar. Guar is a gelling agent used in fracturing fluids that may increase the viscosity of the fluid. Increasing the viscosity of the fluid may lower the frictional pressure drop experienced by the fluid as the fluid travels through the wellbore. For turbulent fluid flow, Equation 3 may be substituted for Equation 1. The pressure gradient for turbulent flow may be computed by:

$$\begin{matrix}\frac{D Δ p}{4 L} = {K}^{′} {{{X}_{s} ( \frac{8 V}{D} )}^{n} [ 1 + {( \frac{V}{{V}_{t}} )}^{α} ]}^{\frac{s - n}{α}} \\ where & ( 3 ) \\ {K}^{′} = {K ( \frac{1 + 3 n}{4} )}^{n} = index parameter ; & ( 4 ) \\ {V}_{t} = {( \frac{4 {K}^{′} {8}^{n}}{{AD}^{e - s + n}} )}^{\frac{1}{s - n}} {( {X}_{s} )}^{\frac{s - n}{2 - n}} ; & ( 5 )\end{matrix}$$

Vₜ=transition velocity to the turbulent regime;
α=4=transition power index;
Xₛ=fluid correction factor;
n=flow behavior index; and
K=flow consistency index.

The transition power index, α, may be equal to approximately four and may be experimentally determined. The flow behavior index, n, is a dimensionless parameter and indicates the type of fluid. The flow behavior index equals one for Newtonian fluids, less than one for pseudoplastic fluids, and greater than one for dilatant fluids.

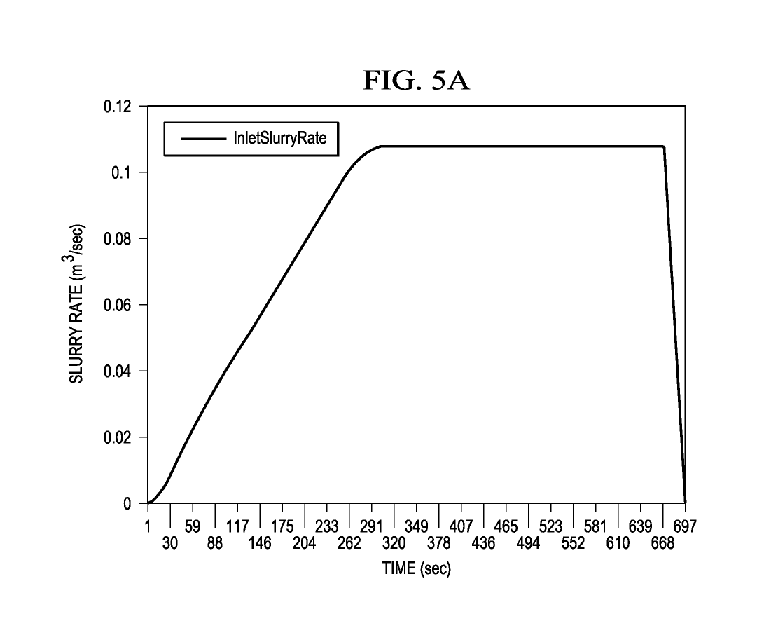

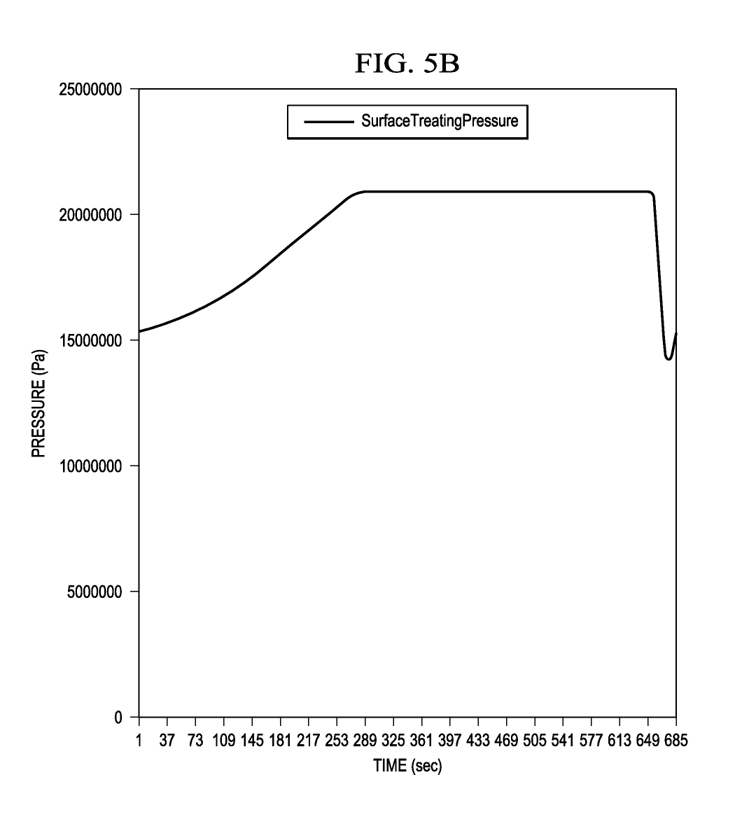

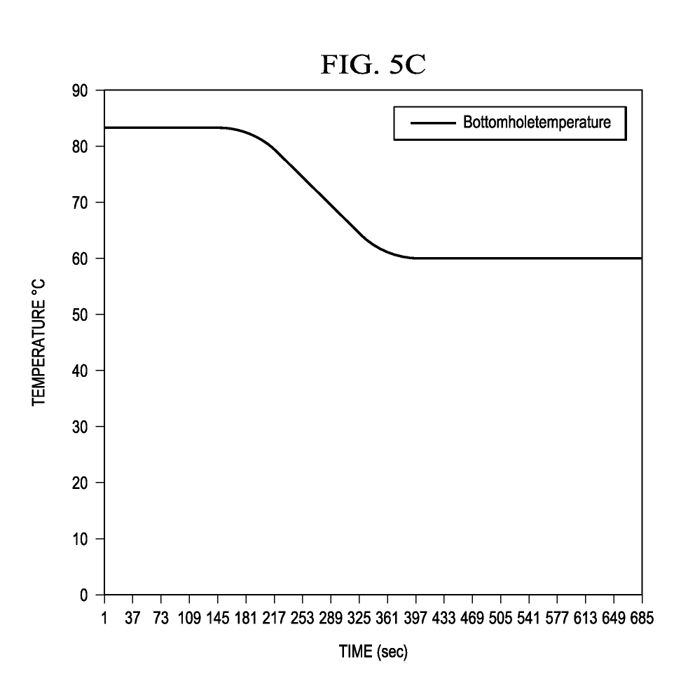

At step 406, the wellbore modeling system may model any discontinuity created by the perforations in the wellbore. The discontinuity created by the perforations may be modeled based on the characteristics of the fluid as the fluid travels through the wellbore. The velocity and the temperature of the fluid at the inlet of the wellbore may be determined based on the pumping schedule of the fluid and the ambient temperature at the inlet of the wellbore (e.g. the most uphole portion of the wellbore). The pumping schedule may define the quantity of fluid or a flow rate of fluid that is to be pumped into a wellbore as a function of time. FIG. 5A illustrates one example of a pumping schedule. The velocity at the downhole end of the wellbore may be zero because all fluid may have been lost through the perforations. At a perforation, the velocity of the fluid may be discontinuous due to fluid exiting the wellbore through the perforation. The exiting of fluid through the perforation may cause an infinite velocity gradient. The discontinuity may be modeled by setting the pressure at a point uphole of the perforation equal to the pressure at a point downhole of the perforation. The pressure across a perforation may be continuous even though the velocity of the fluid may not be continuous. The point uphole of the perforation and the point downhole of the perforation may be selected to be points near the perforation.

The discontinuity of the velocity of the fluid may be modeled by computing the mass balance equation obtained by balancing the flow entering the perforation and flow loss at the perforation. Fluid may be lost at the perforation due to fluid exiting the wellbore and entering the formation. The flow loss may be calculated using the orifice equation, by estimating the flow loss, or any other suitable method for calculating flow loss. For example, the orifice equation describing the flow of liquid through an orifice may be:

Q=A×V (6)

where
Q=flow through the perforation;
A=area of the perforation; and
V=velocity of the fluid.

The temperature of the fluid at a point uphole of the perforation may be set to equal the temperature of the fluid a point downhole of the perforation. The temperature of the fluid may be continuous across a perforation. The boundary conditions for the temperature of the fluid may be computed via the same method: by setting the boundary conditions for temperature of the fluid at a point uphole of the perforation may be set to equal the boundary conditions for the temperature of the fluid a point downhole of the perforation.

The discontinuities at each perforation may be calculated via the method described in step 404. However, at the last perforation, or most downhole perforation, the pressure, velocity, and temperature of the fluid may be zero because all fluid has left the relevant portion of the wellbore through the last perforation. The relevant portion of the wellbore may be the perforated portion of the wellbore. The relevant portion of the wellbore may include some or all portions of the wellbore uphole of the perforations. For purposes of modeling the discontinuities at the last perforation, the pressure of the fluid at a point downhole of the perforation may be set to equal the pressure of the fluid at the wellbore inlet. The pressure of the fluid at a point uphole of the perforation may be calculated as a function of the uphole perforation variables. Similarly, the temperature of the fluid at a point downhole of the perforation may be set to equal the temperature of the fluid at the wellbore inlet. The temperature of the fluid at a point uphole of the perforation may be calculated as a function of the uphole perforation variables, such as fluid flow rate, fluid pressure, cross-sectional area of the wellbore, and/or other properties of the fluid.

At step 406, the wellbore modeling system may solve the momentum equation for the fluid to determine the pressure and the velocity of the fluid. The momentum may be averaged across the cross-sectional area of the wellbore. The momentum equation for the fluid may be:

$$\begin{matrix}\frac{\partial A ρ v}{\partial t} + \frac{\partial A ρ {v}^{2}}{\partial η} + μ \frac{{\partial }^{2} v}{\partial {η}^{2}} A \frac{\partial P}{\partial η} + A \frac{d p}{d L} {\vert}_{friction} - A ρℊ cos θ = 0 \\ Assuming \text{:} & ( 7 ) \\ \frac{\partial v}{\partial η} = 0 & ( 8 )\end{matrix}$$

where
A=cross-sectional area of the wellbore;
ρ=density of the fluid;
ν=velocity of the fluid;
t=time;
η=arbitrary coordinate along the wellbore axis;
μ=dynamic viscosity coefficient of the fluid;
P=pressure of the fluid;
p=pressure decrease due to friction;
L=length of the relevant part of the wellbore; and
θ=angle between the axis of symmetry of the wellbore and the horizon.

In order to solve Equation 7, the factors of Equation 7 may be discretized. Discretization is the process of converting a continuous differential equation in to a discrete difference equation. A discretized equation may be more suitable for computation on a computer. The elements of Equation 7 may be discretized using any suitable known method for discretization. For example, the pressure gradient of Equation 7 may be discretized as:

$$A \frac{\partial P}{\partial η} = {A}_{i} \frac{{P}_{i + 1} - {P}_{i}}{Δη} \qquad ( 9 )$$

where i is an incremental time step during the pumping schedule. For example, Pᵢ is the pressure of the fluid at a time i during the pumping schedule and Pᵢ₊₁ is the pressure of the fluid at a time i+1 after time i. Other elements of Equation 7 may be discretized in a similar manner.

At step 408, the wellbore modeling system may determine the temperature of the fluid by solving the energy balance equation. The energy balance between the fluid, the wellbore, and the earth may be determined by:

$$\begin{matrix}\frac{\partial E}{\partial t} = - \frac{\partial }{\partial η} ( ( E + {P}_{m} - \frac{4 {μ}_{m}}{3} \frac{\partial {v}_{m}}{\partial η} ) {v}_{m} ) + q + {ρ}_{m} {v}_{m} ℊ sin θ \\ where & ( 10 ) \\ E = \frac{1}{2} {ρ}_{m} {v}_{m}^{2} + U = energy of the system ; & ( 11 ) \\ q = {U}_{t 0} ( T - {T}_{e} ) = amount of heat loss ; & ( 12 )\end{matrix}$$

ρₘ=density of the fluid;
νₘ=velocity of the fluid;
μₘ=viscosity of the fluid;
g=gravitational acceleration;
U=internal energy;
Uₜ₀=overall heat transfer coefficient; and
Tₑ=temperature of the earth.

The overall heat transfer coefficient, Uₜ₀, may be the sum of the thermal resistances of the annulus, casing, cement, and the earth, as described with respect to FIG. 2. The overall heat transfer coefficient may include other layers between the fluid and the formation. Energy may be transferred through each layer of the wellbore and the formation. The temperature of the formation may vary as a function of depth. In modeling the thermal conductivity of the formation, the formation may be assumed to be an infinite cylinder.

In order to solve Equation 10, the factors of Equation 10 may be discretized as described with reference to Equation 9. The elements of Equation 10 may be discretized using any suitable known method for discretization, such as a method similar to that shown in Equation 9 with respect to discretizing Equation 7.

While calculating the solution to the fluid momentum and energy balance, the calculation of pressure of the fluid and the velocity of the fluid may be coupled due to the interaction between pressure and velocity. For example, the velocity of the fluid may change the pressure of the fluid and the pressure of the fluid may change the velocity of the fluid. Due to this interaction, solving equations containing both pressure and velocity as variables may be difficult. Therefore, the momentum equation (Equation 7) and the energy balance equation (Equation 10) may be solved in a staggered fashion. For example, at each discrete point along the wellbore, only pressure or velocity may be calculated. For example, at a point 1, the pressure of the fluid may be calculated and the velocity of the fluid may be set equal to the velocity at a point 0, which may be uphole of point 1. At point 2, the velocity of the fluid may be calculated and the pressure of the fluid may be set to the pressure of the fluid calculated at point 1. Point 2 may be downhole of point 1. In cases where point 0 is the inlet of the wellbore, the velocity of the fluid may be determined based on the pumping schedule.

At step 410, the wellbore modeling system may determine if the fluid pumping is complete. If the fluid pumping is complete, the fluid may be no longer moving and method 400 may proceed to step 412. If the fluid pumping is not complete, method 400 may return to step 402 to calculate the temperature of the fluid at the next time step in the pumping schedule.

At step 412, the wellbore modeling system may use the temperature of the fluid to model fluid properties. For example, the temperature of the fluid may impact the viscosity of the fluid. The viscosity of the fluid may be adjusted based on the temperature calculated in step 408 and may be used in other wellbore modeling systems. The viscosity of the fluid may impact the flow rate of the fluid. The fluid flow rate may be used to model the conditions in the wellbore and provide data for designing a stimulation operation. For example, for fracturing operations, the pressure at which the fluid exits a perforation (which may be referred to as the “exit pressure” of the fluid) may be an important parameter for designing an effective stimulation operation. The fluid flow rate may be used to calculate the exit pressure of the fluid. The density of the fluid may also be determined based on the temperature. The fluid properties may be used to provide a representation of the conditions in the wellbore and may be used during the design of a stimulation operation to enable an engineer to adjust the parameters of the stimulation operation to achieve the required results. For example an engineer may adjust the number of perforations, the pumping schedule, the size of the perforations, the thickness of the layers of the wellbore (e.g., the casing or the cement), or any other suitable parameter impacting the stimulation operation. The fluid properties may be used real-time during a stimulation operation to represent the conditions in the wellbore. The conditions in the wellbore may enable an operator to monitor and/or adjust the stimulation operation if necessary. For example, during a fracturing operation, the viscosity of the fluid entering a fracture may determine the amount of fluid delivered and the distance the fluid may be carried into the fracture.

Method 400 may be used for both steady and unsteady fluid flow. Method 400 may also be used for compressible and incompressible fluid flow and for Newtonian and non-Newtonian fluids.

FIGS. 5A-5C illustrate the results from an exemplary embodiment of method 400 as shown in FIG. 4, in accordance with some embodiments of the present disclosure. A simulation was performed for the case of a straight wellbore with two perforations. The flow rate of the fluid was linearly increased from zero cubic-meters per second to approximately 0.11 cubic-meters per second and held constant. At the end of the pumping schedule the flow rate of the fluid was ramped back down to zero cubic-meters per second, as shown in FIG. 5A.

The pressure of the fluid is shown in FIG. 5B. The pressure of the fluid increased as the flow rate of the fluid increased and remained constant while the flow rate of the fluid remains constant. At the end of the pumping schedule, the pressure decreased as the flow rate of the fluid decreased and then slightly increased to the hydrostatic pressure with no flow. The hydrostatic pressure of the fluid is the pressure of the fluid due to gravity.

The bottomhole temperature is shown in FIG. 5C. The initial temperature is the temperature of the fluid at the inlet of the wellbore. In FIG. 5C, the initial temperature was approximately eighty-three degrees Celsius. The bottomhole temperature cooled to approximately fifty-eight degrees Celsius which was approximately the steady-state temperature. The fluid cooled to the steady-state temperature when approximately 2.4 wellbore volumes of fluid had been pumped into the wellbore based on the pumping schedule, as shown in FIG. 5A.

Although the present disclosure and its advantages have been described in detail, it should be understood that various changes, substitutions and alterations can be made herein without departing from the spirit and scope of the disclosure as defined by the following claims. For example, while the embodiment discussed describes a calculation for Newtonian, non-compressible flow, the method disclosed may be used for compressible flow and for non-Newtonian fluids.

What is claimed is:

1. A method of modeling one-dimensional temperature distribution calculations in a wellbore, the method comprising:
estimating a pressure gradient of a fluid in a wellbore;
calculating a pressure of the fluid in the wellbore based on the pressure gradient of the fluid;
computing a velocity of the fluid in the wellbore;
determining a temperature of the fluid in the wellbore based on the pressure of the fluid and the velocity of the fluid;
using the temperature of the fluid to determine a fluid property; and
selecting parameters for a stimulation operation based on the fluid property.

2. The method of claim 1, wherein calculating the pressure of the fluid and computing the velocity of the fluid further includes:
calculating the velocity of the fluid at a first point in the wellbore;
computing a pressure of the fluid at a second point in the wellbore based on the velocity of the fluid at the first point; and
calculating the velocity of the fluid at a third point in the wellbore based on the pressure of the fluid at the second point.

3. The method of claim 1, further comprising modeling a discontinuity of the velocity of the fluid at a perforation in the wellbore.

4. The method of claim 3, wherein modeling the discontinuity of the velocity of the fluid at the perforation in the wellbore further includes calculating the fluid flow loss at the perforation.

5. The method of claim 3, wherein modeling the discontinuity of the velocity of the fluid at the perforation in the wellbore further includes holding the temperature of the fluid and the pressure of the fluid constant across the perforation.

6. The method of claim 1, wherein calculating the temperature of the fluid in the wellbore is based on an overall heat transfer coefficient of a formation and at least one layer of the wellbore.

7. The method of claim 1, wherein the fluid is an unsteady fluid.

8. A non-transitory machine-readable medium comprising instructions stored therein, the instructions executable by one or more processors to facilitate performing a method of modeling one-dimensional temperature distribution calculations in a wellbore, the method comprising:
estimating a pressure gradient of a fluid in a wellbore;
calculating a pressure of the fluid in the wellbore based on the pressure gradient of the fluid;
computing a velocity of the fluid in the wellbore;
determining a temperature of the fluid in the wellbore based on the pressure of the fluid and the velocity of the fluid;
using the temperature of the fluid to determine a fluid property; and
selecting parameters for a stimulation operation based on the fluid property.

9. The non-transitory machine-readable medium of claim 8, wherein calculating the pressure of the fluid and computing the velocity of the fluid further includes:
calculating the velocity of the fluid at a first point in the wellbore;
computing a pressure of the fluid at a second point in the wellbore based on the velocity of the fluid at the first point; and
calculating the velocity of the fluid at a third point in the wellbore based on the pressure of the fluid at the second point.

10. The non-transitory machine-readable medium of claim 8, further comprising modeling a discontinuity of the velocity of the fluid at a perforation in the wellbore.

11. The non-transitory machine-readable medium of claim 10, wherein modeling the discontinuity of the velocity of the fluid at the perforation in the wellbore further includes calculating the fluid flow loss at the perforation.

12. The non-transitory machine-readable medium of claim 10, wherein modeling the discontinuity of the velocity of the fluid at the perforation in the wellbore further includes holding the temperature of the fluid and the pressure of the fluid constant across the perforation.

13. The non-transitory machine-readable medium of claim 8, wherein calculating the temperature of the fluid in the wellbore is based on an overall heat transfer coefficient of a formation and at least one layer of the wellbore.

14. The non-transitory machine-readable medium of claim 8, wherein the fluid is an unsteady fluid.

15. A drilling system, comprising:
a wellbore, including a plurality of perforations;
a fluid inserted into the wellbore; and
a modeling system configured to model the one-dimensional temperature distribution of the fluid in the perforated wellbore
estimating a pressure gradient of the fluid in the wellbore;
calculating a pressure of the fluid in the wellbore based on the pressure gradient of the fluid;
computing a velocity of the fluid in the wellbore;
determining a temperature of the fluid in the wellbore based on the pressure of the fluid and the velocity of the fluid;
using the temperature of the fluid to determine a fluid property; and
selecting parameters for a stimulation operation based on the fluid property.

16. The drilling system of claim 15, wherein calculating the pressure of the fluid and computing the velocity of the fluid further includes:
calculating the velocity of the fluid at a first point in the wellbore;
computing a pressure of the fluid at a second point in the wellbore based on the velocity of the fluid at the first point; and
calculating the velocity of the fluid at a third point in the wellbore based on the pressure of the fluid at the second point.

17. The drilling system of claim 15, further comprising modeling a discontinuity of the velocity of the fluid at a perforation in the wellbore.

18. The drilling system of claim 17, wherein modeling the discontinuity of the velocity of the fluid at the perforation in the wellbore further includes:
calculating the fluid flow loss at the perforation; and
holding the temperature of the fluid and the pressure of the fluid constant across the perforation.

19. The drilling system of claim 15, wherein calculating the temperature of the fluid in the wellbore is based on an overall heat transfer coefficient of a formation and at least one layer of the wellbore.

20. The drilling system of claim 15, wherein the fluid is an unsteady fluid.
